(19) United States
(12) Patent Application Publication
(10) Pub. No.: US 2002/0011112 A1
(43) Pub. Date: Jan. 31, 2002

(54) Micromechanical component

(76) Inventors: Andreas Kipp, Reutlingen (DE); Stefan Pinter, Reutlingen (DE); Frank Fischer, Gomaringen (DE)

Correspondence Address: KENYON & KENYON, ONE BROADWAY, NEW YORK, NY, 10004, US

(21) Appl. No.: 09/860,844

(22) Filed: May 18, 2001

(30) Foreign Application Priority Data
May 18, 2000 (DE) 1 00 24 698.2

(51) Int. Cl. G01L 1/00; G01H 1/00; G01N 3/32; G01M 7/00

(52) U.S. Cl. 73/579

(57) ABSTRACT

A micromechanical component, in particular an acceleration sensor, having a seismic mass which is resiliently supported on a substrate via a cantilever spring device and which can be deflected by an acceleration in at least one direction, it being possible for the deflection of the seismic mass to be limited by a first limit limit stop device and the cantilever spring device being attached at the side of the seismic mass. A second limit limit stop device for limiting a bending of the cantilever spring device is provided which prevents the cantilever spring device from sticking to adjacent parts in the case of overload accelerations.

### FIELD OF THE INVENTION

The present invention relates to a micromechanical component, in particular an acceleration sensor, having a seismic mass which is resiliently supported on a substrate via a cantilever spring device and which can be deflected by an acceleration in at least one direction, it being possible for the deflection of the seismic mass to be limited by a first limit stop device, and the cantilever spring device being attached at the side of the seismic mass.

### BACKGROUND INFORMATION

Although applicable to any micromechanical components and structures, in particular sensors and actuators, the present invention as well as its underlying problem will be explained with respect to a micromechanical Coriolis acceleration sensor of a rotational rate sensor, the Coriolis acceleration sensor being manufacturable using the technology of silicon surface micromechanics.

Acceleration sensors in general and, in particular, micromechanical acceleration sensors in the technology of surface or bulk micromechnics are gaining larger and larger market segments in automotive equipment applications, increasingly replacing the piezoelectric acceleration sensors customary heretofore.

The known micromechanical acceleration sensors usually function in such a way that the resiliently supported seismic mass device, which can be deflected by an external acceleration in at least one direction, brings about a change in capacitance of a differential capacitor device which is connected thereto, the change in capacitance being a measure for the acceleration. These elements are usually patterned in epitaxial polysilicon above a sacrificial layer of oxide.

Accelerations sensors are known in which the deflection of the seismic mass can be limited by one or a plurality of fixed limit stops which are placed, for example, in a cutout of the seismic mass or on an anchoring of the seismic mass.

FIG. 4 shows a partial top view of a known acceleration sensor.

In FIG. 4, reference symbol 1 denotes a substrate made of silicon above which an oblong seismic mass 10 is elastically suspended at an anchoring 20 via a looped cantilever spring 40. Seismic mass 10 can be deflected by an acceleration in direction P, cantilever spring 40 including loop 45 exerting a restoring force with respect to such an acceleration. Limit stops 200 having the form of small knobs are attached to anchoring 20. 30 denotes a block which is fixedly anchored in substrate 1. 50 is a base for fixed comb teeth 70, 72; and 60, 62 are movable comb teeth which are laterally attached to seismic mass 10 and which have a double beam structure. d1 denotes the distance of the looped spring 40 from block 30; d2 denotes the distance of the looped spring from adjacent comb tooth 60; and d3 denotes the distance of seismic mass 10 from the anchoring in the balanced condition. The fixed and movable comb teeth form a known differential capacitor device.

It has turned out to be a disadvantage of the known acceleration sensors that, subsequent to overload accelerations, seismic mass 10, as the central electrode, can stick or adhere to such fixed limit stops 200 because of adhesive forces and/or due to electrostatic forces resulting from charges because the restoring force of the springs is too low. On the other hand, an increase of the restoring force of the springs would have a negative effect on the measuring sensitivity.

Furthermore, a sticking does not only occur in the case of seismic mass 10 at anchoring 20 but also in the case of looped spring 40 at adjacent base 30 or at comb tooth 60.

This sticking is to be understood as a direct and permanent contact between elements of the movable seismic mass, the spring device of the system and the fixedly tied or anchored component parts of the component. Such sticking structures impair the functionality of the component and can result in 0 km failures (immediate failures) or later field failures.

### SUMMARY OF THE INVENTION

The micromechanical component according to the present invention has the advantage that the spring device of the component can be effectively prevented from sticking.

A basic idea of the present invention is to provide a second limit stop device for limiting a bending of the cantilever spring device, the second limit stop device preventing the cantilever spring device from sticking to adjacent parts in the case of overload accelerations. The second limit stop device does not change the functionality of the component, and all functional parameters of the design can be maintained constant. No technological problems are expected, and the appertaining layout can be implemented without greater outlay.

According to a preferred embodiment, the second limit stop device includes limit stops which are attached to a fixed block next to the cantilever spring device.

According to a further preferred refinement, the second limit stop device includes limit stops which are attached to a movable comb tooth next to the cantilever spring device.

According to another preferred embodiment, the second limit stop device includes limit stops which are attached to the cantilever spring device.

According to a further preferred refinement, the cantilever spring device includes a looped spring.

According to another preferred embodiment, the second limit stop device includes limit stops which are attached to the loop of the cantilever spring device.

According to a further preferred refinement, the first limit stop device includes limit stops which are attached to an anchoring in the moving direction of the seismic mass.

According to another preferred embodiment, a maximum of two limit stops are attached to the anchoring in the moving direction of the seismic mass.

According to a further preferred refinement, provision is made for a differential capacitor device having a plurality of movable and fixed comb teeth which feature a double beam structure, the movable comb teeth being laterally attached to the seismic mass.

### BRIEF DESCRIPTION OF THE DRAWINGS

FIG. 1 shows a partial top view of an acceleration sensor according to a first embodiment of the present invention.

FIG. 2 shows a partial top view of an acceleration sensor according to a second embodiment of the present invention.

FIG. 3 shows a partial top view of an acceleration sensor according to a third embodiment of the present invention.

FIG. 4 shows a partial top view of a known acceleration sensor.

### DETAILED DESCRIPTION

In the Figures, identical or functionally identical components are denoted by the same reference symbols.

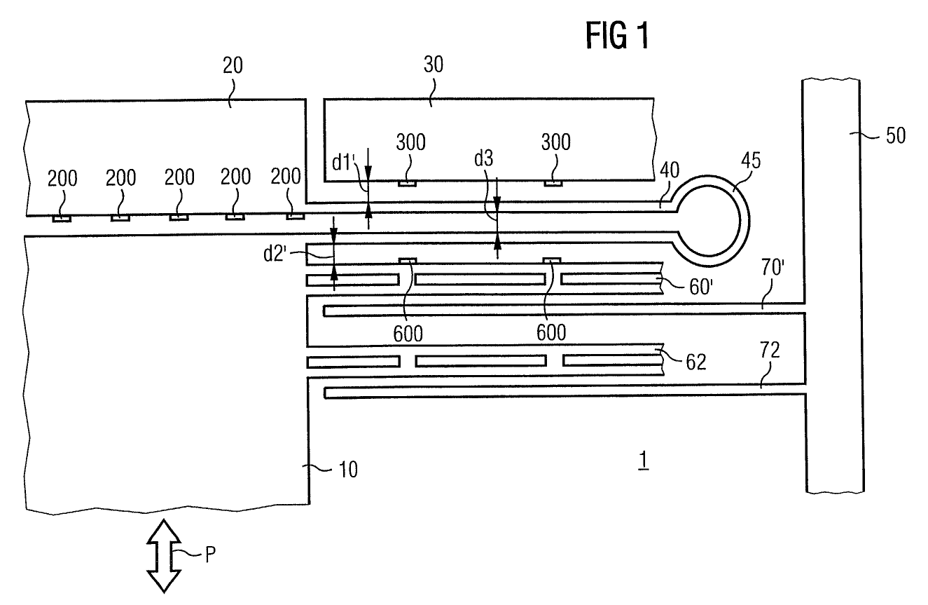

FIG. 1 shows a partial top view of an acceleration sensor according to a first embodiment of the present invention.

In FIG. 1, in addition to the already introduced reference symbols, d1′ denotes an enlarged distance between block 30 and looped spring 40, d2′ denotes an enlarged distance between looped spring 40 and comb tooth 60′, comb tooth 70′ being also displaced in this connection.

In FIG. 1, moreover, 300 denotes limit stops of a second limit stop device which are attached to block 30, and 600 denotes limit stops of the second limit stop device which are attached to comb tooth 60′ on the side of looped spring 40.

Furthermore, the epitaxial polysilicon structure of base 30 which borders looped spring 40 together with the beam structures, is set further back by distance d1′ to prevent electrostatic forces due to charge redistributions and adhesive forces which act when looped spring 40 approaches base 30. The same applies to distance d2′ between looped spring 40 and adjacent comb tooth 60′.

These measures have three essential effects, while the mechanical sensitivity remains unchanged.

On one hand, the arising disturbance forces have to be much larger to deflect the spring up to base 30 or up to adjacent comb tooth 60′ and, on the other hand, the restoring force of looped spring 40 is much higher in the case of larger deflection, thus preventing a clinging or sticking to the spring surroundings in the form of base 30 and comb tooth 60′.

Finally, spacers or limit stops 300, 600 in the form of knobs prevent looped spring 40 from getting too close to base 30 or to adjacent comb tooth 60′ over a large surface.

All these measures result in that looped spring 40 can be effectively prevented from sticking.

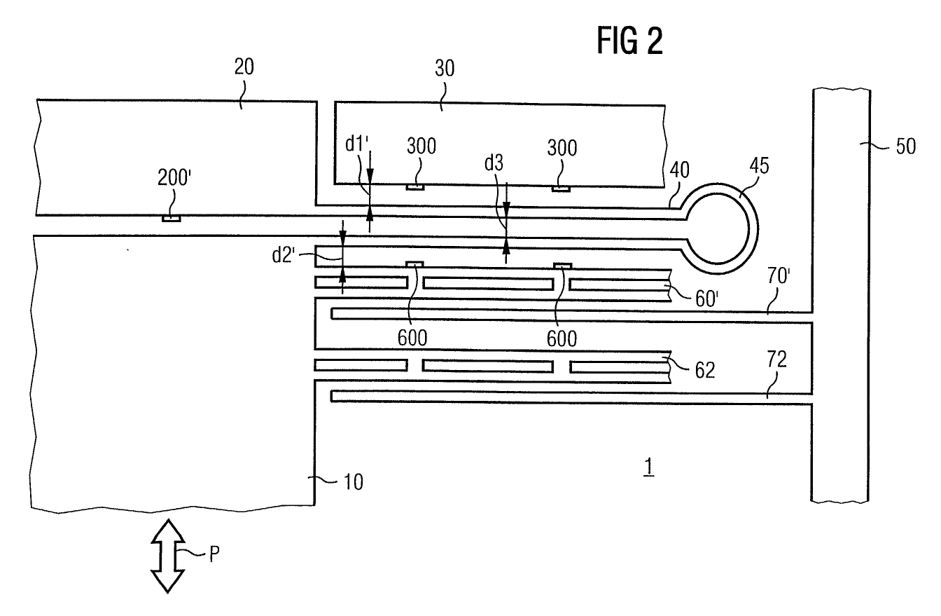

FIG. 2 shows a partial top view of an acceleration sensor according to a second embodiment of the present invention.

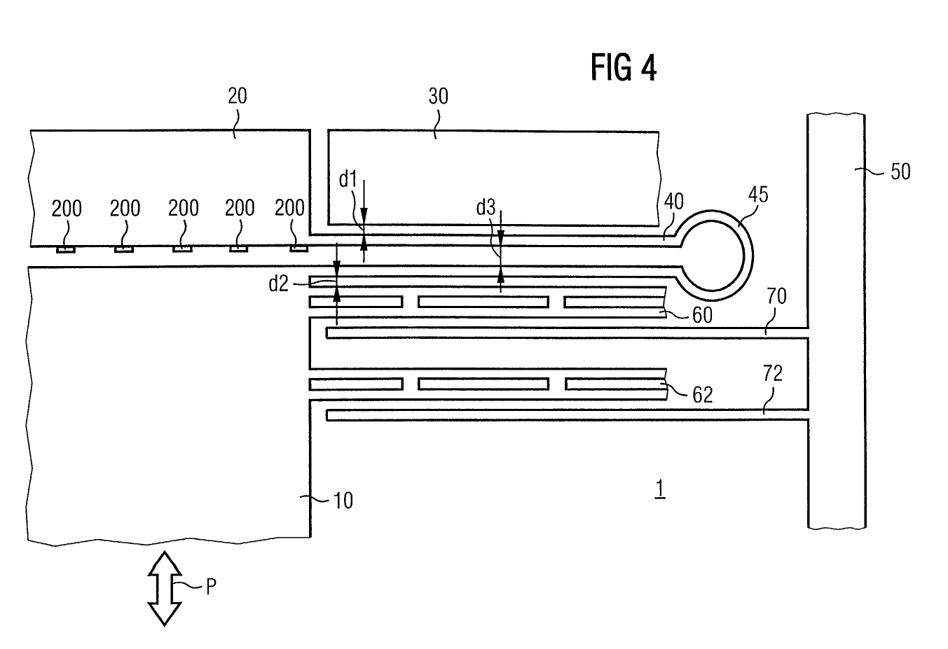

According to the second embodiment of FIG. 2, the number of fixed limit stops on anchoring 20 is reduced to one. In other words, only one knob 200′ exists since limit stops 200 according to FIG. 4 are potential sticking points and a high number of such limit stops markedly increases the probability of sticking. In principle, a maximum of two limit stops 200′ of that kind are sufficient to form an effective limit stop in the moving direction of seismic mass 10.

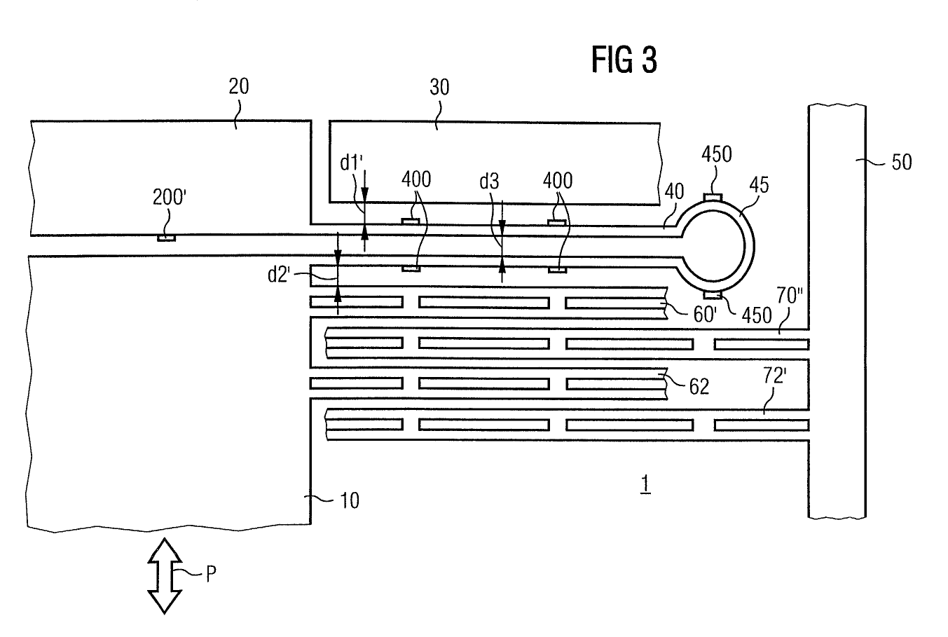

FIG. 3 shows a partial top view of an acceleration sensor according to a third embodiment of the present invention.

In the third embodiment according to FIG. 3, in contrast to the second embodiment and to the first embodiment, the second limit stop device is implemented in the form of limit stops 400 on the straight parts of looped spring 40 and limit stops 450 on loop 45 of looped spring 40.

In addition, fixed comb teeth 70″, 72′ or electrode fingers are stiffened by increasing their width and forming a double beam structure for strongly reducing the deflection of these comb teeth 70″ and 72′ and for preventing these parts from sticking. As mentioned before, the stiffening is achieved by multiply connected double beams.

Although the present invention has been described above on the basis of a preferred exemplary embodiment, it is not limited thereto but modifiable in many ways.

In the above examples, the acceleration sensor according to the present invention has been explained in simple forms to illustrate its basic principles. Combinations of the examples and considerably more complex designs using the same elements are, of course, conceivable.

Of course, limit stops can also be provided both on the looped spring and on the adjacent base and on the adjacent comb tooth, respectively. Such limit stops can be situated opposite each other or be attached in a manner that they are staggered relative to each other.

It is also possible to use any micromechanical base materials and not only the exemplarily mentioned silicon substrate.

What is claimed is:

1. A micromechanical component comprising:
a substrate;
a seismic mass capable of being deflected by an acceleration in at least one direction;
a cantilever spring device for resiliently supporting the seismic mass on the substrate, the cantilever spring device being attached at a side of the seismic mass;
a first limit stop device for limiting a deflection of the seismic mass; and
a second limit stop device for limiting a bending of the cantilever spring device.

2. The micromechanical component according to claim 1, wherein the micromechanical component is an acceleration sensor.

3. The micromechanical component according to claim 1, wherein the second limit stop device includes limit stops attached to a fixed block adjacent to the cantilever spring device.

4. The micromechanical component according to claim 1, wherein the second limit stop device includes limit stops attached to a movable comb tooth adjacent to the cantilever spring device.

5. The micromechanical component according to claim 1, wherein the second limit stop device includes limit stops attached to the cantilever spring device.

6. The micromechanical component according to claim 1, wherein the cantilever spring device includes a looped spring.

7. The micromechanical component according to claim 6, wherein the second limit stop device includes limit stops attached to a loop of the cantilever spring device.

8. The micromechanical component according to claim 1, wherein the first limit stop device includes limit stops attached to an anchoring in a moving direction of the seismic mass.

9. The micromechanical component according to claim 8, wherein the first limit stop device includes two limit stops, a maximum of the two limit stops being attached to the anchoring in the moving direction of the seismic mass.

10. The micromechanical component according to claim 1, further comprising a differential capacitor device having a plurality of movable and fixed comb teeth having a double beam structure, the movable comb teeth being laterally attached to the seismic mass.
